(19) United States
(12) Patent Application Publication
(10) Pub. No.: US 2021/0056550 A1
(43) Pub. Date: Feb. 25, 2021

(54) METHOD AND SYSTEM FOR CURRENCY TRANSFER CONFIRMATION

(71) Applicant: Paul G. LEWIS, Asbury, NJ (US)

(72) Inventor: Paul G. LEWIS, Asbury, NJ (US)

(21) Appl. No.: 17/000,715

(22) Filed: Aug. 24, 2020

Related U.S. Application Data
(60) Provisional application No. 62/890,258, filed on Aug. 22, 2019.

(51) Int. Cl. G06Q 20/40; G06Q 30/00; G06Q 40/02; G06Q 20/38

(52) U.S. Cl. CPC G06Q 20/4014; G06Q 30/0185; G06Q 40/08; G06Q 20/389; G06Q 40/02

(57) ABSTRACT

An embodiment of the present disclosure provides a method comprising: establishing a connection between a device of a currency sender and a device of a currency requester, the currency requester being associated with a currency account to which currency is to be sent; causing the device of the currency sender to: indicate personal identification information received from the currency requester; indicate personal identification information associated with the device of the currency requester; and when the device of the currency sender receives a first confirmation of the personal currency account, indicate a confirmation that authenticity of the currency account is verified; authorizing a transfer of currency between the currency sender and the currency requester upon receipt of confirmation from the device of the currency sender.

### CROSS-REFERENCE TO RELATED APPLICATIONS

This application claims the benefit of U.S. Provisional Application No. 62/890,258, filed Aug. 22, 2019, the contents of which are incorporated by reference herein.

### FIELD

The present disclosure generally relates to method and system for currency transfer confirmation, in particular for wire transfer confirmation.

### BACKGROUND

In recent years, cyber criminals have duped individuals and businesses by redirecting a valid wire transfer between two parties to an unknown third party. In addition, cyber criminals have requested funds be wired through what looks to be an urgent request from a trusted party. The cyber tactics utilized are complex and convincing, resulting in losses of over $12 Billion (FBI, Alert Number I-071218-PSA). Cyber criminals utilize deception tactics including Phishing, Business Email Compromise (BEC), Email Account Compromise (EAC), social engineering, and other scams.

Cyber criminals are deliberately and creatively targeting wire transfers, and using various techniques, such as email scams to convince senders to initiate transfers. Senders typically assume that banks will redeposit funds transferred fraudulently. However, banks are not typically at fault if a legitimate wire transfer is sent to an account identified by a sender. Accordingly, the sender of the wire is the victim, but banks are suffering from a public relations perspective even if they are not directly victimized or at fault.

These scams continue to grow and evolve, targeting small, medium, and large businesses and personal transactions. Between December 2016 and May 2018, there was a 136% increase in identified global exposed losses. The scam has been reported in all 50 states and in 150 countries. Victim complaints filed with the IC3 (“Internet Crime Complaint Center,” operated by the Federal Bureau of Investigation) and financial sources indicate fraudulent transfers have been sent to 115 countries.

### SUMMARY

The present disclosure provides an improved way of a currency transfer. For example, the present disclosure provides safe way for two parties to confirm bank wire information to protect against wire fraud. The system uses state of the art technology and verification systems to ensure the sender and receiver information is accurate before a wire transfer is staged. If the wire transfer is lost to a cyber-criminal, the loss is insured for up to $1 Million.

An embodiment of the present disclosure provides a method comprising: establishing a connection between a device of a currency sender and a device of a currency requester, the currency requester being associated with a currency account to which currency is to be sent; causing the device of the currency sender to: indicate personal identification information received from the currency requester; indicate personal identification information associated with the device of the currency requester; and when the device of the currency sender receives a first confirmation of the personal currency account, indicate a confirmation that authenticity of the currency account is verified; authorizing a transfer of currency between the currency sender and the currency requester upon receipt of confirmation from the device of the currency sender.

In one embodiment, the personal identification information received from the currency requester includes at least one of: an image of the currency requester; a name of the currency requester; contact information of the currency requester. The personal identification information associated with the device of the currency requestor includes at least one of: a location of the device of the currency requester; an owner name of an account associated with the device.

In one embodiment, the method further includes causing the device of the currency sender to: during indicating the personal identification information of the currency requester, indicate currency account information of the currency account that is associated with the currency requester, and an amount of the currency that is to be sent to the currency account.

In one embodiment, the currency account information of the currency account that is associated with the currency requester includes at least one of: a bank account number; a bank name; and a registered location of a bank account.

In one embodiment, the method further includes causing the device of the currency sender to: during indicating the personal identification information of the currency requester, indicate personal identification information of the currency sender.

In one embodiment, the personal identification information of the currency sender includes at least one of: an image of the currency sender; a name of the currency sender; a contact information of the currency sender; and a location of the device of the currency sender.

In one embodiment, the personal identification information received from the currency requester includes: a first image of the currency requester, the first image including a realtime video image. The personal identification information received from the device of the currency requestor includes a first location of the device of the currency requester, the first location being based on GPS location data of the device of the currency requester. The personal identification information of the currency sender includes: a second image of the currency sender, the second image including a realtime video image; and a second location of the device of the currency sender, the second location being based on GPS location data of the device of the currency sender.

In one embodiment, the method further includes: receiving confirmation from the device of the currency sender that the indications of personal identification information of the currency requester are acceptable; receiving confirmation from the device of the currency requester that the indications of personal identification information of the currency sender are acceptable; after authorizing the transaction, storing a record of the transaction and the confirmations received for use in insuring a wire transaction from the currency sender.

In one embodiment, the method further includes causing the device of the currency sender to: indicate a request of verification by the currency sender on the indicated personal identification information of the currency requester; and when the device of the currency sender receives the first confirmation of the personal currency account after the request of the verification by the currency sender is indicated, indicate the confirmation that authenticity of the currency account is verified.

In one embodiment, the method further includes: causing the device of the currency requester to indicate: personal identification information of the currency sender; and a request of verification by the currency requester, and causing the device of the currency sender to indicate the confirmation that authenticity of the currency account is verified, when the device of the currency requester receives a second confirmation of the personal currency account after the request of the verification by the currency requester.

In one embodiment, the method further includes causing the device of the currency sender to: send, to the device of the requester, a request of the connection between the device of the sender and the device of the requester to establish the connection between the device of the currency sender and the device of the currency requester.

Another embodiment of the present disclosure provides a device of a currency sender comprising: a processor configured to: establish a connection between the device of the currency sender and a device of a currency requester, the currency requester being associated with a currency account to which currency is to be sent; indicate personal identification information received from the currency requester; indicate personal identification information associated with the device of the currency requester; and when the device of the currency sender receives a first confirmation of the personal currency account, indicate a confirmation that authenticity of the currency account is verified; and authorize a transfer of currency between the currency sender and the currency requester upon receipt of confirmation from the device of the currency sender.

In one embodiment, the personal identification information received from the currency requester includes at least one of: an image of the currency requester; a name of the currency requester; and contact information of the currency requester. The personal identification information associated with the device of the currency requestor includes at least one of: a location of the device of the currency requester; an owner name of an account associated with the device.

In one embodiment, the device further includes a display configured to display the personal identification information received from the currency requester and the personal identification information associated with the device of the currency requestor.

In one embodiment, the processor is further configured to: during indicating the personal identification information of the currency requester, indicate currency account information of the currency account that is associated with the currency requester, and an amount of the currency that is to be sent to the currency account.

In one embodiment, the currency account information of the currency account that is associated with the currency requester includes at least one of: a bank account number; a bank name; and a registered location of a bank account.

In one embodiment, the processor is further configured to: during indicating the personal identification information of the currency requester, indicate personal identification information of the currency sender.

In one embodiment, the personal identification information of the currency sender includes at least one of: an image of the currency sender; a name of the currency sender; a contact information of the currency sender; and a location of the device of the currency sender.

In one embodiment, the processor is further configured to: indicate a request of verification by the currency sender on the indicated personal identification information of the currency requester; and when the device of the currency sender receives the first confirmation of the personal currency account after the request of the verification by the currency sender is indicated, indicate the confirmation that authenticity of the currency account is verified.

In one embodiment, the processor is further configured to: send, to the device of the requester, a request of the connection between the device of the sender and the device of the requester to establish the connection between the device of the currency sender and the device of the currency requester.

Another embodiment of the present disclosure provides a non-transitory computer-readable medium having one or more executable instructions stored thereon, which executed by a processor, cause the processor to perform a method comprising: establishing a connection between a device of a currency sender and a device of a currency requester, the currency requester being associated with a currency account to which currency is to be sent; causing the device of the currency sender to: indicate personal identification information received from the currency requester; indicate personal identification information associated with the device of the currency requester; and when the device of the currency sender receives a first confirmation of the personal currency account, indicate a confirmation that authenticity of the currency account is verified; authorizing a transfer of currency between the currency sender and the currency requester upon receipt of confirmation from the device of the currency sender.

Another embodiment of the present disclosure provides a method for insuring a transaction comprising: establishing a connection between a device of a currency sender and a device of a currency requester, the currency requester being associated with a currency account to which currency is to be sent; causing the device of the currency sender to: indicate personal identification information received from the currency requester; indicate personal identification information associated with the device of the currency requester; and when the device of the currency sender receives a first confirmation of the personal currency account, indicate currency account information provided by the currency sender and a confirmation that authenticity of the currency account is verified; receiving confirmation from the device of the currency sender that the indications of personal identification information of the currency requester are acceptable; receiving confirmation from the device of the currency requester that the indications of personal identification information of the currency sender are acceptable; authorizing a transfer of currency between the currency sender and the currency requester upon receipt of confirmation from the device of the currency sender; generating a record of the transaction and the confirmations received, the record including the personal identification information received from the currency requester and associated with the device of the currency request; transmitting the record of the transaction to an insuring entity.

### BRIEF DESCRIPTION OF THE DRAWINGS

FIG. 1 illustrates a system according to one embodiment of the present disclosure.

FIGS. 2A and 2B illustrate flowcharts according to one embodiment of the present method.

FIGS. 3-11 illustrate examples of displayed contents according to one embodiment of the present disclosure.

### DETAILED DESCRIPTION OF THE PREFERRED EMBODIMENTS

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

The present embodiment may use technology to verify the wiring instructions between two parties before a transfer is staged. This is accomplished through verification of data including proper matching of the sender's and receiver's name, physical location, bank, account number, and amount of transfer through a secure portal that relies on 2-Factor Authentication, Facial Recognition, Geo-Location, Verified Sending Bank Name, Verified Receiving Bank Name and Location, and Security Token. The present embodiment makes it simple for both parties to agree on the wire details and automatically verifies the authenticity of the sender and receiver. Once confirmed, the wire is staged through the sender's bank.

The system and method described may operate as an independent and insured verification process to approve the identity of the sender and receiver of a wire transfer. Transactions may be insured directly by a company implementing the system or method, or transactions may generate a receipt to be sent to a third party insuring agency.

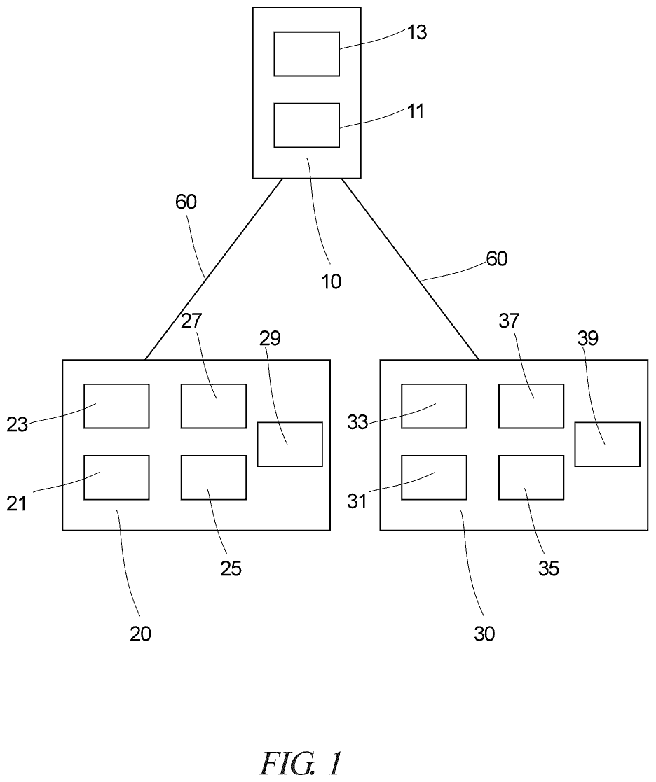

As shown in FIG. 1, a system may include a server 10 and devices 20 and 30. The system may be used for transferring currency. The currency may include real money (e.g., fiat currency) and digital money (e.g., crypto-currency). Typically, the system may be used for real money wire transfer. The server 10 may include a processor 11 and a memory that stores data. Each of the he devices 20 and 30 may typically be a smartphone, but may be a cellphone, a laptop computer, a desktop computer, and a tablet computer. The device 20 may include: a processor 21; a memory 23 that may store data; a camera 25 that may capture a face of a user of the device 20; a geolocator 27 that may obtain data of a location of the device 20 (GPS location data of the device 20); and a display 29 that may display information discussed below. The device 30 may include: a processor 31; a memory 33 that may store data; a camera 35 that may capture a face of a user of the device 30; a geolocator 37 that may obtain data of a location of the device 30 (GPS location data of the device 30); and a display 39 that may display information discussed below. In the illustrated example, the device 20 may be a device of a currency sender, and the device 30 may be a currency requester. The currency requester may be the same as a receiver of the currency but may be different from a receiver of the currency. That is, the requester may request transferring of the currency on behalf of the currency receiver.

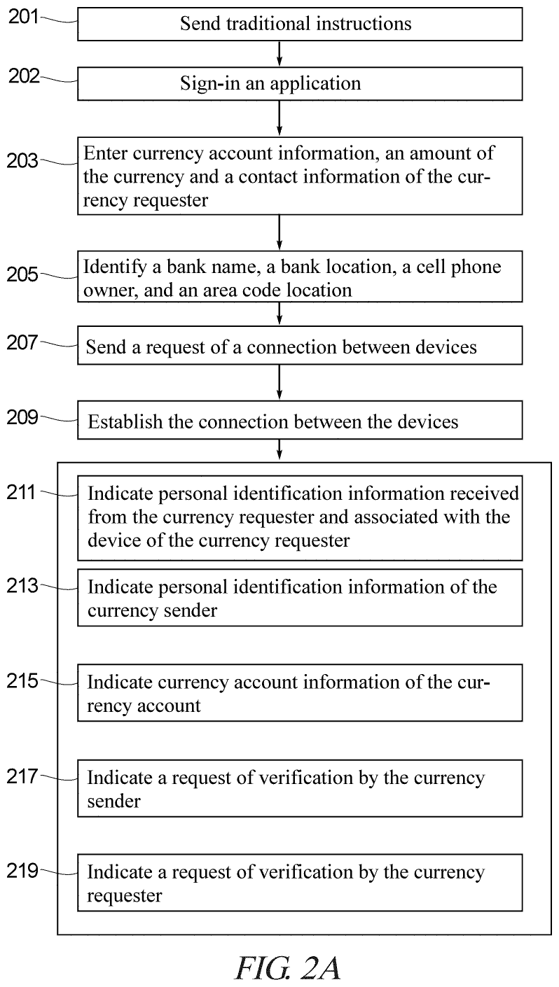

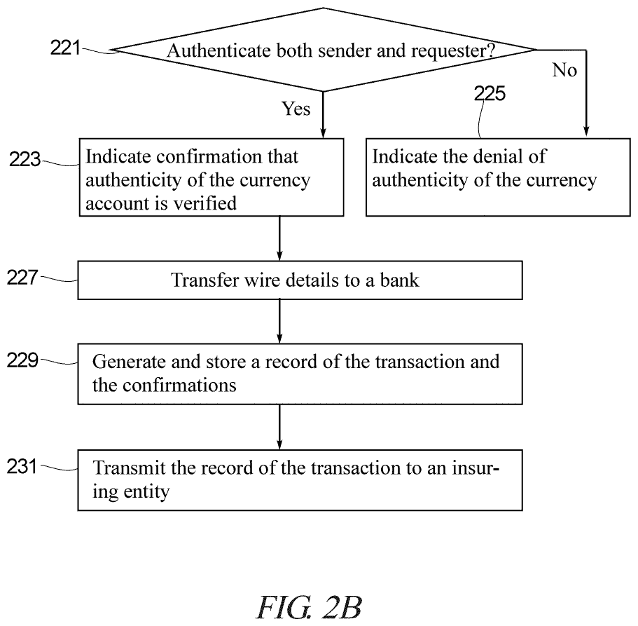

FIGS. 2A and 2B show exemplary flowcharts of the present method.

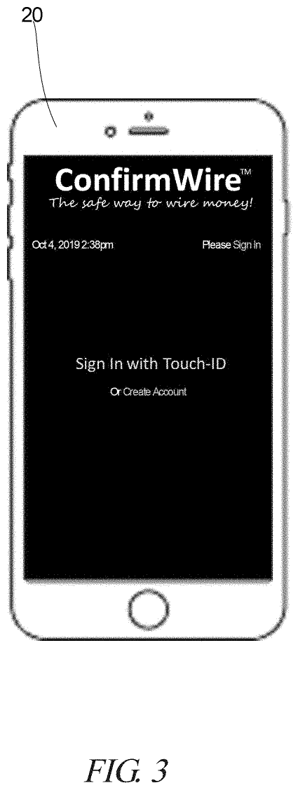

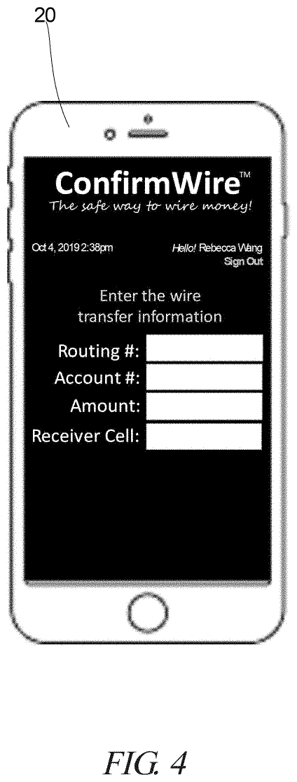

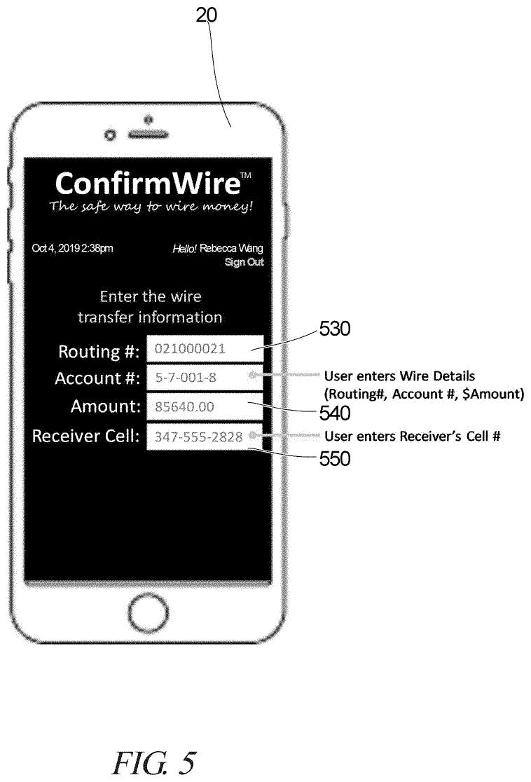

First, the requester or the receiver may send to the sender traditional instructions for transferring currency, for example, by email, phone call, etc. (201 of FIG. 2A). As shown in FIG. 3, the sender may sign-in an application of the present system, which may be installed in the device 20 of the currency sender (202 of FIG. 2A). As shown in FIGS. 4-5, the sender may enter currency account information 530 of the currency account that is associated with the currency requester, an amount 540 of the currency that is to be sent to the currency account, and contact information 550 of the currency requester (203 of FIG. 2A). In the example of FIG. 5, the currency account information 530 may include a routing number of the receiving bank account, and an account number of the receiving bank account. The contact information 550 of the currency requester may include a phone number of the currency requester.

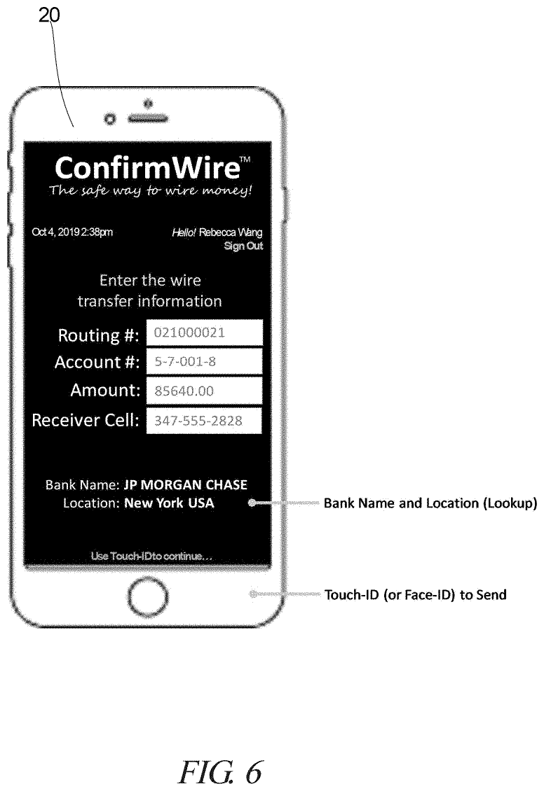

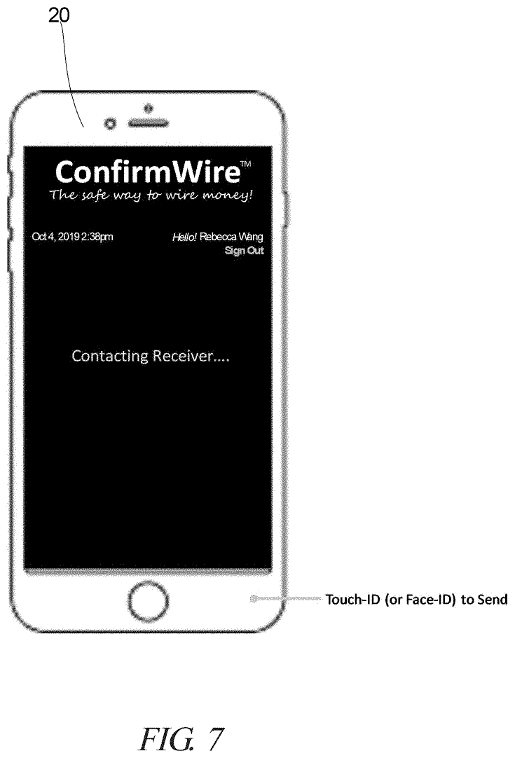

Then, as shown in FIG. 6, the application or the server 10 may automatically identify a receiving bank name from the routing number, and indicate the bank name and the bank's location (205 of FIG. 2A). Then, the application or the server 10 may identify a cell phone owner and an area code location (reverse look-up) (205 of FIG. 2A). Then, with reference to FIG. 7, once the currency sender confirms the bank name and the area code location by using touch ID or face ID, the application or the server 10 may send, to the device of the requester, a request of the connection 60 (see FIG. 1) between the device of the sender and the device of the requester to establish the connection 60 between the device 20 of the currency sender and the device 30 of the currency requester (207 of FIG. 2A). The request of the connection 60 may be a short message or an email message.

When the requester receives the request of the connection 60, and accepts the request of the connection 60 (e.g., by clicking a link in the short message or an email message), the connection 60 between the device 20 of the currency sender and the device 30 of the currency requester may be established (209 of FIG. 2A).

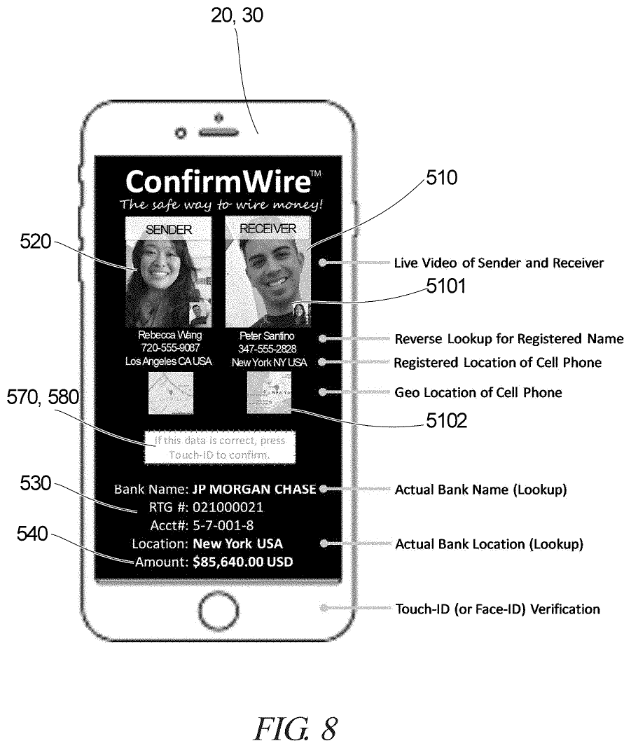

With reference to FIG. 8, once the connection 60 between the device 20 of the currency sender and the device 30 of the currency requester is established, the server 10 or the application may cause the device 20 of the currency sender to indicate personal identification information 510 (211 of FIG. 2A). The information 510 may be displayed on the display of the device 20 of the currency sender. The personal identification information 510 may include personal identification information 5101 received from the currency requester, and personal identification information 5102 associated with the device 30 of the currency requester. The personal identification information 5101 received from the currency requester may include at least one of: an image of the currency requester; a name of the currency requester; and contact information of the currency requester. The personal identification information 5102 associated with the device 30 of the currency requester may include at least one of: a location of the device of the currency requester; and an owner name of an account associated with the device. The image of the currency requester may include a realtime video image of a face of the currency requester. The location of the device 30 of the currency requester may be based on GPS location data of the device 30 of the currency requester. The location of the device 30 of the currency requester may include a mapped location of the device 30 of the currency requester and an area (e.g., a city, a state, or a country) of the location of the device 30 of the currency requester.

As shown in FIG. 8, the server 10 or the application may cause the device 20 of the currency sender to, during indicating the personal identification information 510 of the currency requester, indicate personal identification information 520 of the currency sender (213 of FIG. 2A). The personal identification information 520 of the currency sender may be displayed on the display of the device 20 of the currency sender. The personal identification information 520 of the currency sender may include at least one of: an image of the currency sender; a name of the currency sender; a contact information of the currency sender; and a location of the device 20 of the currency sender. The image of the currency sender may include a realtime video image of a face of the currency sender. The location of the device 20 of the currency sender may be based on GPS location data of the device 20 of the currency sender. The location of the device 20 of the currency sender may include a mapped location of the device 20 of the currency sender and an area (e.g., a city, a state, or a country) of the location of the device 20 of the currency sender.

As shown in FIG. 8, the server 10 or the application may cause the device 20 of the currency sender to, during indicating the personal identification information 510 of the currency requester, indicate the currency account information 530 of the currency account that is associated with the currency requester, and the amount 540 of the currency that is to be sent to the currency account (215 of FIG. 2A). The indication of the currency account information 530 and the amount 540 may be displayed on the display of the device 20. The currency account information 530 of the currency account that is associated with the currency requester may include at least one of: a bank account number; a bank name; and a registered location of a bank account.

As shown in FIG. 8, the server 10 or the application may cause the device 20 of the currency sender to indicate a request 570 of verification by the currency sender on the indicated personal identification information 510 of the currency requester (217 of FIG. 2A). The request 570 may be displayed on the display of the device 20.

Similar to the device 20 of the currency sender, the server 10 or the application may cause the device 30 of the currency requester to indicate information 510, 520, 530, 540, and 550 on a display of the device 30 of the currency requester. Further, as shown in FIG. 8, the server 10 or the application may cause the device 30 of the currency requester to indicate a request 580 of verification by the currency requester. The request 580 may be displayed on the display of the device 30 (219 of FIG. 2A).

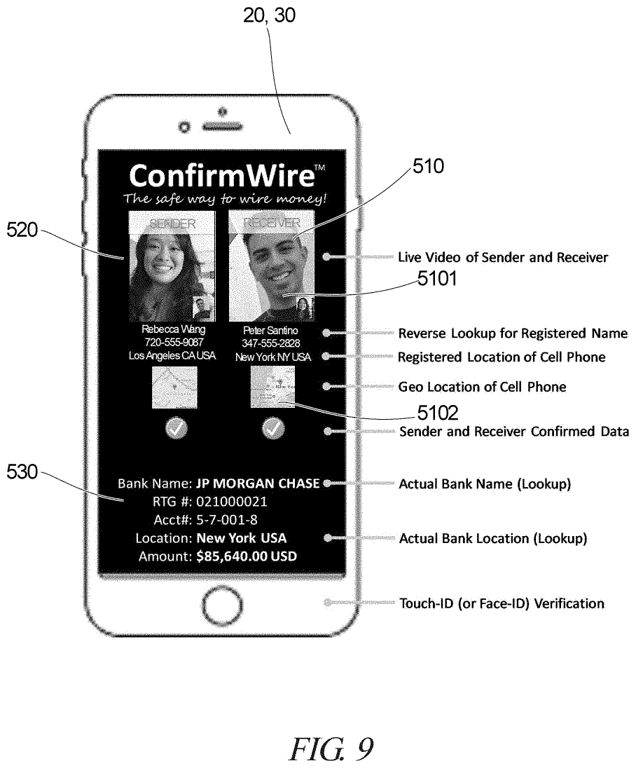

In 221 of FIG. 2B, in reference with FIG. 9, the server 10 or the application may authenticate both sender and requester as authorized on the respective devices 20 and 30, when the device 20 of the currency sender receives a first confirmation of the personal currency account after the request 570 of the verification by the currency sender is indicated, and when the device 30 of the currency requester receives a second confirmation of the personal currency account after the request 580 of the verification by the currency requester. Each confirmation of the personal currency account may be conducted by using touch ID or face ID of the respective devices 20 and 30. As such, the server 10 or the application may authenticate a transfer of currency between the currency sender and the currency requester upon receipt of confirmation from the device 20 of the currency sender, or from both the device 20 of the currency sender and the device 30 of the currency requester.

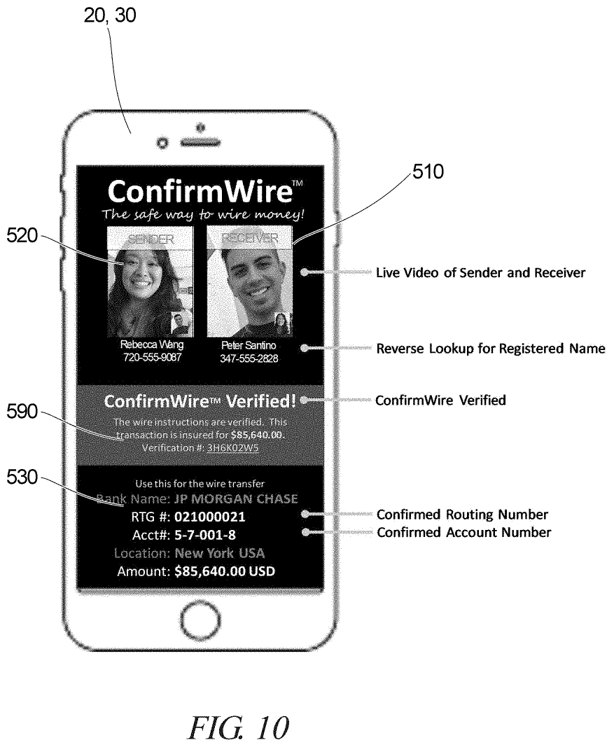

Then, as shown in FIG. 10, the server 10 or the application may cause the devices 20 and 30 of the currency sender and requester to indicate the confirmation 590 that authenticity of the currency account is verified (223 of FIG. 2B).

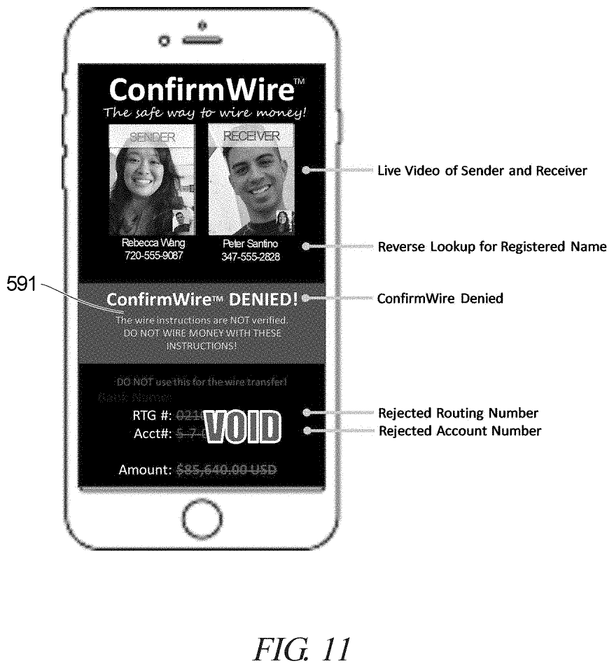

As shown in FIG. 11, when the device 20 of the currency sender or the device 30 of the currency requester does not receive a confirmation, the server 10 or the application may cause the devices 20 and 30 of the currency sender and requester to indicate the denial 591 of authenticity of the currency account (225 of FIG. 2B).

Then, wire details can be safely transferred to the bank (227 of FIG. 2B), for example from the server 10. The server 10 or the application may generate and store a record of the transaction and the confirmations received for use in insuring a wire transaction from the currency sender (229 of FIG. 2B). The server 10 or the application may transmit the record of the transaction to an insuring entity (231 of FIG. 2B). As such, “digital handshake” is archived. If funds do not arrive at the agreed to account, the transaction is covered by the insurance company. The sender receives a code through the application. The transaction is insured for the entire amount of the wire transfer (up to, for example, $1,000,000 US). The benefit of the present system and method may include at least one of:

(1) Simple, insurable, “Handshake” between the sender and the requester/receiver;

(2) No complex KYC, sanctions screening, watchlists, etc;

(3) Protects the goodwill of the Banking Industry; and

(4) Protects the sender for wire transfers up to, for example, $1,000,000 US.

The methods according to the present disclosure may be implemented on a computer as a computer implemented method, or in dedicated hardware, or in a combination of both. Executable code for a method according to the present disclosure may be stored on a computer program product. Examples of computer program products include memory devices, optical storage devices, integrated circuits, servers, online software, etc. Preferably, the computer program product may include non-transitory program code stored on a computer readable medium for performing a method according to the invention when said program product is executed on a computer. In an embodiment, the computer program may include computer program code adapted to perform all the steps of a method according to the invention when the computer program is run on a computer. The computer program may be embodied on a computer readable medium.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method comprising:
establishing a connection between a device of a currency sender and a device of a currency requester, the currency requester being associated with a currency account to which currency is to be sent;
causing the device of the currency sender to:
indicate personal identification information received from the currency requester;
indicate personal identification information associated with the device of the currency requester; and
when the device of the currency sender receives a first confirmation of the personal currency account, indicate a confirmation that authenticity of the currency account is verified;
authorizing a transfer of currency between the currency sender and the currency requester upon receipt of confirmation from the device of the currency sender.

2. The method of claim 1, wherein the personal identification information received from the currency requester includes at least one of: an image of the currency requester; a name of the currency requester; contact information of the currency requester; and
wherein the personal identification information associated with the device of the currency requestor includes at least one of: a location of the device of the currency requester; an owner name of an account associated with the device.

3. The method of claim 1, further comprising causing the device of the currency sender to:
during indicating the personal identification information of the currency requester, indicate currency account information of the currency account that is associated with the currency requester, and an amount of the currency that is to be sent to the currency account.

4. The method of claim 3, wherein the currency account information of the currency account that is associated with the currency requester includes at least one of: a bank account number; a bank name; and a registered location of a bank account.

5. The method of claim 3, further comprising causing the device of the currency sender to:
during indicating the personal identification information of the currency requester, indicate personal identification information of the currency sender.

6. The method of claim 5, wherein the personal identification information of the currency sender includes at least one of: an image of the currency sender; a name of the currency sender; a contact information of the currency sender; and a location of the device of the currency sender.

7. The method of claim 5, wherein the personal identification information received from the currency requester includes:
a first image of the currency requester, the first image including a realtime video image; and
wherein the personal identification information received from the device of the currency requestor includes a first location of the device of the currency requester, the first location being based on GPS location data of the device of the currency requester, and
the personal identification information of the currency sender includes:
a second image of the currency sender, the second image including a realtime video image; and
a second location of the device of the currency sender, the second location being based on GPS location data of the device of the currency sender.

8. The method of claim 5, further comprising:
receiving confirmation from the device of the currency sender that the indications of personal identification information of the currency requester are acceptable;
receiving confirmation from the device of the currency requester that the indications of personal identification information of the currency sender are acceptable;
after authorizing the transaction, storing a record of the transaction and the confirmations received for use in insuring a wire transaction from the currency sender.

9. The method of claim 5, further comprising causing the device of the currency sender to:
indicate a request of verification by the currency sender on the indicated personal identification information of the currency requester; and
when the device of the currency sender receives the first confirmation of the personal currency account after the request of the verification by the currency sender is indicated, indicate the confirmation that authenticity of the currency account is verified.

10. The method of claim 9, further comprising:
causing the device of the currency requester to indicate: personal identification information of the currency sender; and a request of verification by the currency requester, and
causing the device of the currency sender to indicate the confirmation that authenticity of the currency account is verified, when the device of the currency requester receives a second confirmation of the personal currency account after the request of the verification by the currency requester.

11. The method of claim 6, further comprising causing the device of the currency sender to:
send, to the device of the requester, a request of the connection between the device of the sender and the device of the requester to establish the connection between the device of the currency sender and the device of the currency requester.

12. A device of a currency sender comprising:
a processor configured to:
establish a connection between the device of the currency sender and a device of a currency requester, the currency requester being associated with a currency account to which currency is to be sent;
indicate personal identification information received from the currency requester;
indicate personal identification information associated with the device of the currency requester; and
when the device of the currency sender receives a first confirmation of the personal currency account, indicate a confirmation that authenticity of the currency account is verified; and
authorize a transfer of currency between the currency sender and the currency requester upon receipt of confirmation from the device of the currency sender.

13. The device of claim 12, wherein the personal identification information received from the currency requester includes at least one of: an image of the currency requester; a name of the currency requester; and contact information of the currency requester, and
wherein the personal identification information associated with the device of the currency requestor includes at least one of: a location of the device of the currency requester; an owner name of an account associated with the device.

14. The device of claim 12, further comprising:
a display configured to display the personal identification information received from the currency requester and the personal identification information associated with the device of the currency requestor.

15. The device of claim 12, wherein the processor is further configured to:
during indicating the personal identification information of the currency requester, indicate currency account information of the currency account that is associated with the currency requester, and an amount of the currency that is to be sent to the currency account.

16. The device of claim 15, wherein the currency account information of the currency account that is associated with the currency requester includes at least one of: a bank account number; a bank name; and a registered location of a bank account.

17. The device of claim 15, wherein the processor is further configured to:
during indicating the personal identification information of the currency requester, indicate personal identification information of the currency sender.

18. The device of claim 17, wherein the personal identification information of the currency sender includes at least one of: an image of the currency sender; a name of the currency sender; a contact information of the currency sender; and a location of the device of the currency sender.

19. The device of claim 18, wherein the processor is further configured to:
indicate a request of verification by the currency sender on the indicated personal identification information of the currency requester; and
when the device of the currency sender receives the first confirmation of the personal currency account after the request of the verification by the currency sender is indicated, indicate the confirmation that authenticity of the currency account is verified,
wherein the processor is further configured to:
send, to the device of the requester, a request of the connection between the device of the sender and the device of the requester to establish the connection between the device of the currency sender and the device of the currency requester.

20. A method for insuring a transaction comprising:
establishing a connection between a device of a currency sender and a device of a currency requester, the currency requester being associated with a currency account to which currency is to be sent;
causing the device of the currency sender to:
indicate personal identification information received from the currency requester;
indicate personal identification information associated with the device of the currency requester; and
when the device of the currency sender receives a first confirmation of the personal currency account, indicate currency account information provided by the currency sender and a confirmation that authenticity of the currency account is verified;
receiving confirmation from the device of the currency sender that the indications of personal identification information of the currency requester are acceptable;
receiving confirmation from the device of the currency requester that the indications of personal identification information of the currency sender are acceptable;
authorizing a transfer of currency between the currency sender and the currency requester upon receipt of confirmation from the device of the currency sender;
generating a record of the transaction and the confirmations received, the record including the personal identification information received from the currency requester and associated with the device of the currency request;
transmitting the record of the transaction to an insuring entity.
